(19) United States
(12) Patent Application Publication
(10) Pub. No.: US 2016/0244549 A1
(43) Pub. Date: Aug. 25, 2016

(54) ALKOXYSILANE-GROUP MODIFIED POLYURETHANES AND LOW MODULUS SEALANTS FORMED THEREFROM

(71) Applicant: Bayer MaterialScience LLC, Pittsburgh, PA (US)

(72) Inventors: Jay Johnston, Clinton, PA (US); Ayla Pasquini, Pittsburgh, PA (US)

(73) Assignee: Bayer MaterialScience LLC

(21) Appl. No.: 14/631,251

(22) Filed: Feb. 25, 2015

(51) Int. Cl. C08G 18/71; C08G 18/04; C09K 3/10; C08G 18/48

(52) U.S. Cl. CPC C08G 18/718; C08G 18/4825; C08G 18/04; C09K 3/1021; C08G 2190/00

(57) ABSTRACT

Disclosed are alkoxysilane-group modified polyurethane that are the reaction product of: (1) a polyoxyalkylene diol; and (2) an isocyanate-functional silane. Also disclosed are compositions, including sealant compositions, that include such polyurethanes, and cured sealant formed from such compositions.

The present invention relates to alkoxysilane-group modified polyurethanes, compositions that include such polyurethanes, sealants exhibiting a low modulus formed from such compositions, and methods for using such compositions to seal a joint edge of joined substrates.

### BACKGROUND

Polyurethane sealants are widely used in building materials as waterproofing agents, environmental barriers, and to accommodate changes in the size of materials due to thermal, moisture and structural movements, including vibration and creep. As such, polyurethane sealant compositions are often applied at, for example, expansion joints, control joints, and perimeter joints, of substrates, such as concrete substrates.

Low-modulus polyurethane sealants are used in a variety of applications, such as where a joint or aperture over which the sealant is used is subject to significant movement. Specific examples of such applications are, without limitation, fenestration sealants, flashing, sealants between tilt-up concrete panels, and high-rise façade sealants. It is understood that a low modulus sealant exhibits a 100% modulus of no more than 60 pounds per square inch (0.41 MPa), when measured according to ASTM D412, Method A.

Historically, to produce low modulus sealants, it has been necessary to use a significant amount (often >18% by weight, based on the total weight of the composition) of plasticizer in the formulation. A plasticizer is an organic liquid or solid that is incorporated into the formulation with a compatible base resin to reduce interaction between molecules and improve molecular mobility, thereby making the resin more flexible. Plasticizers are typically inert to the base resin. Examplary plasticizers are adipates, benzoates, citrates, phosphates, phthalates, trimellitates, esters, oils, sulfonamides, and polymeric plasticizers. A disadvantage of using plasticizer, particularly in high quantities, is that since the plasticizer is not incorporated into the base resin backbone and is not volatile in use, it tends to “leach out” of the sealant, thereby increasing the risk of staining at joint edges due to migration of the plasticizer into the marginal zones of the joined substrates. Other problems associated with the use of a high amount of plasticizer are increased mildew formation and dirt pick up.

As a result, it would be desirable to provide polyurethanes and compositions comprising such polyurethanes that are suitable for producing low modulus sealants, which exhibit other acceptable sealant properties, while utilizing no more than 15% of the plasticizer in the composition and, in some cases, in which little or no plasticizer is used in the composition.

### SUMMARY

In some respects, the present invention is directed to alkoxysilane-group modified polyurethanes that are the reaction product of: (1) a polyoxyalkylene polyol having a molecular weight of at least 18,000 gram/mole and a content of unsaturated end groups of no more than 0.02 meq/gram polyol, measured according to ASTM D2849-69; and (2) a compound of the formula: ONC—Y—Si—(X)₃, wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80:1.

In certain respects, the present invention is directed to compositions that include such polyurethanes, sealants exhibiting a low modulus formed from such compositions, and methods for using such compositions to seal a joint edge of joined substrates.

In other respects, the present invention is directed to moisture curable compositions comprising: (a) an alkoxysilane-group modified polyurethane comprising a reaction product of: (1) a polyoxyalkylene polyol having a molecular weight of at least 18,000 gram/mole and a content of unsaturated end groups of no more than 0.07 meq/gram polyol, measured according to ASTM D2849-69; and (2) a compound of the formula: ONC—Y—Si—(X)₃, wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80:1; (b) a filler; and (c) 0 to 15% by weight, based on the total weight of the composition, of an inert plasticizer.

The present invention is also directed to sealants exhibiting a low modulus formed from such compositions and methods for using such compositions to seal a joint edge of joined substrates.

### DETAILED DESCRIPTION

Various embodiments are described and illustrated in this specification to provide an overall understanding of the structure, function, operation, manufacture, and use of the disclosed products and processes. It is understood that the various embodiments described and illustrated in this specification are non-limiting and non-exhaustive. Thus, the invention is not limited by the description of the various non-limiting and non-exhaustive embodiments disclosed in this specification. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. §112 and 35 U.S.C. §132(a). The various embodiments disclosed and described in this specification can comprise, consist of, or consist essentially of the features and characteristics as variously described herein.

Any patent, publication, or other disclosure material identified herein is incorporated herein by reference in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “certain embodiments”, “some embodiments”, “various non-limiting embodiments,” or the like, means that a particular feature or characteristic may be included in an embodiment. Thus, use of such phrases, and similar phrases, in this specification does not necessarily refer to a common embodiment, and may refer to different embodiments. Further, the particular features or characteristics may be combined in any suitable manner in one or more embodiments. Thus, the particular features or characteristics illustrated or described in connection with various embodiments may be combined, in whole or in part, with the features or characteristics of one or more other embodiments without limitation. Such modifications and variations are intended to be included within the scope of the present specification. In this manner, the various embodiments described in this specification are non-limiting and non-exhaustive.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112 and 35 U.S.C. §132(a).

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “polymer” encompasses prepolymers, oligomers and both homopolymers and copolymers; the prefix “poly” in this context referring to two or more. As used herein, the term “molecular weight”, when used with reference to a hydroxyl-functional polymer, refers to a calculated molecular weight, which is determined by measuring the hydroxyl number of the polymer by ASTM D2849-69 Part 26 (1975) and then calculating the molecular weight by the formula: molecular weight=(56100×functionality)/hydroxyl number.

As indicated, in some respects, the present invention is directed to alkoxysilane-group modified polyurethanes. These alkoxysilane-group modified polyurethanes are the reaction product of: (1) a polyoxyalkylene polyol, such as a diol, having a molecular weight of at least 18,000 gram/mole; and (2) a compound of the formula: ONC—Y—Si—(X)₃, wherein: (i) each X independently represents identical or different alkoxy radicals, and (ii) Y represents a difunctional organic radical.

Polyoxyalkyelene polyols, such as diols, used to make the alkoxysilane-group modified polyurethanes of the present invention have a molecular weight of at least 18,000 gram/mole. In certain embodiments, the polyoxyalkylene polyol, such as diol, has a molecular weight of greater than 20,000 gram/mole, such as at least 21,000 gram/mole or at least 22,000 gram/mole and/or up to 30,000 gram/mole or, in some cases, up to 25,000 gram/mole. In certain embodiments, the polyoxyalkyelene polyol used to make the alkoxysilane-group modified polyurethanes of the present invention also have a polydispersity of less than 1.5, such as 1.0 to 1.3 or, in some cases, 1.05 to 1.15. As will be appreciated, polydispersity can be established as known to those skilled in the art, by determining both the number-average molecular weight (Mn) and the weight-average molecular weight (Mw) by gel permeation chromatography (GPC). The polydispersity (PD) is calculated as PD=Mw/Mn.

Polyoxyalkyelene polyols, such as diols, used to make the alkoxysilane-group modified polyurethanes of the present invention have a content of unsaturated end groups of no more than 0.07 meq/gram polyol, measured according to ASTM D2849-69a. In certain embodiments, the polyoxyalkyelene polyol, such as diol, used to make the alkoxysilane-group modified polyurethanes of the present invention has a content of unsaturated end groups of no more than 0.02 meq/gram polyol, such as no more than 0.01 meq/gram polyol, such as, in some cases, 0.008 to 0.01 meq/gram polyol, measured according to ASTM D2849-69a.

Polyoxyalkylene polyols, such as diols, used to make the alkoxysilane-group modified polyurethanes of the present invention can be obtained, for example, by alkoxylation of suitable starter molecules with the use of a double metal cyanide compound as a catalyst (“DMC catalyst”). In certain embodiments, the polyoxylkylene polyol has, on average, 1.5 to 3.5, such as 1.8 to 2.5, hydroxyl groups, per molecule. In some embodiments, the polyoxyalkylene polyol is a diol, i.e., it has 2 hydroxyl groups per molecule.

In certain embodiments, polyoxyalkyelene polyols used to make the alkoxysilane-group modified polyurethanes of the present invention are prepared from one or more hydroxy-functional starter compounds (sometimes referred to herein as “starters” or “starter compound(s)”) and one or more alkylene oxides in the presence of a double metal cyanide catalyst. In some embodiments, the alkylene oxides are metered into the reactor over a period of from 15 to 23 hours, which can provide low viscosity polyols having a very narrow molecular weight distribution.

Suitable hydroxy-functional starter compounds often have 1 to 8, or, such as 2 to 3 or, in yet other cases, 2, hydroxyl groups per molecule (sometimes referred to herein as “H-functionality”). In certain embodiments, the molecular weight of the hydroxyl-functional starter compound is from 18 gram/mole to 1,200 gram/mole. If a mixture of starter compounds is employed, the functionality of this mixture is the number-average functionality of the starter compounds. Non-limiting examples of suitable hydroxyl-functional starter compounds are methanol, ethanol, 1-propanol, 2-propanol and higher aliphatic monoalcohols, such as fatty alcohols, phenol, alkyl-substituted phenols, propylene glycol, ethylene glycol, diethylene glycol, dipropylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, pentaerythritol, sorbitol, sucrose, hydroquinone, pyrocatechol, resorcinol, bisphenol F, bisphenol A, 1,3,5-trihydroxybenzene, and condensates of formaldehyde and phenol or urea containing methylol groups. Highly functional starter compounds based on hydrogenated starch hydrolysis products can also be employed. Ring-opening products from cyclic carboxylic acid anhydrides and polyols can also be employed as starter compounds, such as ring-opening products of phthalic anhydride, succinic anhydride, maleic anhydride on the one hand and ethylene glycol, diethylene glycol, 1,2-butanediol, 1,3-butanediol, 1,4-butanediol, hexanediol, pentanediol, 3-methyl-1,5-pentanediol, 1,12-dodecanediol, glycerol, trimethylolpropane, pentaerythritol or sorbitol on the other hand. In addition, mono- or polyfunctional carboxylic acids may be directly employed as starter compounds.

In certain embodiments, however, a previously prepared alkylene oxide addition product of any of the hydroxyl-functional starter compounds mentioned earlier, i.e., a polyether polyol, such as a polyether diol, with an OH number of from 16 to 1,000 mg of KOH/g, such as 40 to 1,000 mg of KOH/g, is employed, sometimes as the exclusive starter. These alkylene oxide addition products which can be employed either as the exclusive starter or as a (co)starter can be prepared using, for example, a DMC catalyst.

DMC catalysts which are suitable for use in preparing the polyoxyalkyelene polyols used to make the alkoxysilane-group modified polyurethanes of the present invention have a very high activity in the polymerization of alkylene oxides and render possible the preparation of polyether polyols under optimum conditions at very low catalyst concentrations (100 ppm or less), so that it is not necessary to separate off the catalyst from the finished product. In certain embodiments, a highly active DMC catalyst that, in addition to a double metal cyanide compound and an organic complexing ligand, also contains a polyether with a number-average molecular weight of greater than 500 gram/mole, is used. It is also possible to employ the alkaline DMC catalysts disclosed in EP application no. 10163170.3.

In certain embodiments, a cyanide-free metal salt used to prepare the double metal cyanide compound has the general formula: M(X)ₙ, in which M is a metal cation comprising Zn²⁺, Fe²⁺, Ni^{2±}, Mn^{2±}, Co²⁺, Sr²⁺, Sn²⁺, Pb²⁺ and Cu²⁺; each X is an anion (which may be the same or different), such as a halide (i.e. fluoride, chloride, bromide, iodide), hydroxide, sulfate, carbonate, cyanate, thiocyanate, isocyanate, isothiocyanate, carboxylate, oxalate, or nitrate; and n is 1 if X is sulfate, carbonate or oxalate and n is 2 if X is a halide, hydroxide, cyanate, thiocyanate, isocyanate, isothiocyanate or nitrate.

In certain embodiments, a cyanide-free metal salt used to prepare the double metal cyanide compound has the general formula: Mᵣ(X)₃, in which M is a metal cation comprising Fe³⁺, Al³⁺ and Cr³⁺; each X is an anion (which may be the same or different), such as a halide (i.e. fluoride, chloride, bromide, iodide), hydroxide, sulfate, carbonate, cyanate, thiocyanate, isocyanate, isothiocyanate, carboxylate, oxalate or nitrate; and r is 2 if X is sulfate, carbonate or oxalate and r is 1 if X is halide, hydroxide, cyanate, thiocyanate, isocyanate, isothiocyanate, carboxylate or nitrate.

In certain embodiments, a cyanide-free metal salt used to prepare the double metal cyanide compound has the general formula: M(X)ₛ, in which M is a metal cation comprising Mo⁴⁺, V⁴⁺ and W⁴⁺; each X is an anion (which may be the same or different), such as a halide (i.e. fluoride, chloride, bromide, iodide), hydroxide, sulfate, carbonate, cyanate, thiocyanate, isocyanate, isothiocyanate, carboxylate, oxalate or nitrate; and s is 2 if X is sulfate, carbonate or oxalate and s is 4 if X is halide, hydroxide, cyanate, thiocyanate, isocyanate, isothiocyanate, carboxylate or nitrate.

In certain embodiments, a cyanide-free metal salt used to prepare the double metal cyanide compound has the general formula: M(X)ₜ, in which M is a metal cation comprising Mo⁶⁺ and W⁶⁺; each X is an anion (which may be the same or different), such as a halide (i.e. fluoride, chloride, bromide, iodide), hydroxide, sulfate, carbonate, cyanate, thiocyanate, isocyanate, isothiocyanate, carboxylate, oxalate or nitrate; and t is 3 if X is sulfate, carbonate or oxalate and t is 6 if X is halide, hydroxide, cyanate, thiocyanate, isocyanate, isothiocyanate, carboxylate or nitrate.

Specific examples of suitable cyanide-free metal salts are, without limitation, zinc chloride, zinc bromide, zinc iodide, zinc acetate, zinc acetylacetonate, zinc benzoate, zinc nitrate, iron(II) sulfate, iron(II) bromide, iron(II) chloride, cobalt(II) chloride, cobalt(II) thiocyanate, nickel(II) chloride and nickel(II) nitrate, as well as mixtures of two or more thereof.

In certain embodiments, a metal cyanide salt is used to prepare the double metal cyanide compound. Suitable such metal cyanide salts include those having the general formula: (Y)ₐM′(CN)_{b}(A)_{c}, in which M′ is a metal cation comprising Fe(II), Fe(III), Co(II), Co(III), Cr(II), Cr(III), Mn(II), Mn(III), Ir(III), Ni(II), Rh(III), Ru(II), V(IV) and V(V); each Y is independently a metal cation comprising an alkali metal (i.e. Li⁺, Na⁺, K⁺, Rb⁺, Cs⁺) and alkaline earth metal (i.e. Be²⁺, Ca²⁺, Mg²⁺, Sr²⁺, Ba²⁺), each A is independently an anion comprising a halide (i.e. fluoride, chloride, bromide, iodide), hydroxide, sulfate, carbonate, cyanate, thiocyanate, isocyanate, isothiocyanate, carboxylate, oxalate or nitrate; and a, b and c are integers, wherein the values for a, b and c are chosen such that the metal cyanide salt has electroneutrality. In some embodiments, a is 1, 2, 3 or 4; b is 4, 5 or 6; and c is 0.

Specific examples of suitable metal cyanide salts are potassium hexacyanocobaltate(III), potassium hexacyanoferrate(II), potassium hexacyanoferrate(III), calcium hexacyanocobaltate(III) and lithium hexacyanocobaltate(III).

In certain embodiments, the double metal cyanide compound is of the general formula: M_{X}[M′ₓ,(CN)_{y}]_{z}, in which M is any of the metal cations mentioned above with respect to M; M′ is as defined above, and x, x′, y and z are integers and are chosen such that the double metal cyanide compound has electroneutrality. In some embodiments, x is 3, x′ is 1, y is 6 and z is 2, M is Zn(II), Fe(II), Co(II) or Ni(II), and M′ is Co(III), Fe(III), Cr(III) or Ir(III).

Specific examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds are described in, for example, U.S. Pat. No. 5,158,922 at column 8, lines 29-66, the cited portion of which being incorporated herein by reference.

The organic complexing ligands added in the preparation of the DMC catalysts are disclosed, for example, in U.S. Pat. No. 5,158,922 at column 6, lines 9 to 65, the cited portion of which being incorporated herein by reference, as well as U.S. Pat. No. 3,404,109, U.S. Pat. No. 3,829,505, U.S. Pat. No. 3,941,849, EP-A 700949, EP-A 761708, JP-A 4145123, U.S. Pat. No. 5,470,813, EP-A 743 093 and WO-A 97/40086. For example, water-soluble, organic compounds with hetero atoms, such as oxygen, nitrogen, phosphorus or sulfur, which can form complexes with the double metal cyanide compound are employed as organic complexing ligands, examples of which include alcohols, aldehydes, ketones, ethers, esters, amides, ureas, nitriles, sulfides and mixtures thereof. Specific examples of suitable organic complexing ligands are aliphatic ethers (such as dimethoxyethane), water-soluble aliphatic alcohols (such as ethanol, isopropanol, n-butanol, iso-butanol, sec-butanol, tert-butanol, 2-methyl-3-buten-2-ol and 2-methyl-3-butyn-2-ol), and compounds which contain both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetane-methanol). In some embodiments, the organic complexing ligand comprises dimethoxyethane, tert-butanol, 2-methyl-3-buten-2-ol, 2-methyl-3-butyn-2-ol, ethylene glycol mono-tert-butyl ether, 3-methyl-3-oxetane-methanol, or a mixture of two or more thereof.

In some embodiments, one or more complexing component(s) from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, or of glycidyl ethers, glycosides, carboxylic acid esters of polyfunctional alcohols, bile acids or salts, esters or amides thereof, cyclodextrins, phosphorus compounds, α,β-unsaturated carboxylic acid esters or ionic surface- or interface-active compounds are employed in the preparation of the DMC catalysts.

In certain embodiments, in the first step in the preparation of the DMC catalyst, an aqueous solutions of a metal salt (such as zinc chloride), employed in a stoichiometric excess (at least 50 mol %), based on the metal cyanide salt (that is to say at least a molar ratio of cyanide-free metal salt to metal cyanide salt of 2.25 to 1.00), and of the metal cyanide salt (such as potassium hexacyanocobaltate) are reacted in the presence of the organic complexing ligand (such as tert-butanol), so that a suspension which contains the double metal cyanide compound (e.g. zinc hexacyanocobaltate), water, excess cyanide-free metal salt and the organic complexing ligand is formed. The organic complexing ligand can be present in the aqueous solution of the cyanide-free metal salt and/or of the metal cyanide salt, or it can be added directly to the suspension obtained after precipitation of the double metal cyanide compound. The suspension formed in the first step may then be treated with a further complexing component which, if desired, is employed in a mixture with water and organic complexing ligand. One method for carrying out the first step (i.e. the preparation of the suspension) is carried out employing a mixing nozzle, such as a jet disperser as described in WO-A 01/39883.

In the second step the solid (i.e. the precursor of the catalyst) is isolated from the suspension by known techniques, such as centrifugation or filtration.

In some embodiments for preparation of the catalyst, in a third process step the solid which has been isolated is subsequently washed with an aqueous solution of the organic complexing ligand (e.g. by resuspending and subsequent renewed isolation by filtration or centrifugation). Water-soluble by-products, such as potassium chloride, can thereby be removed from the catalyst. In certain embodiments, the amount of organic complexing ligand in the aqueous wash solution is between 40 and 80 wt. %, based on the total solution.

In the third step, further complexing component may be added to the aqueous wash solution, such as in an amount in the range of between 0.5 and 5 percent by weight, based on the total solution.

In some embodiments, the solid which has been isolated is washed more than once. For this, the first washing operation can be repeated. In other cases, however, it may be desirable to use non-aqueous solutions for further washing operations, e.g. a mixture of organic complexing ligand and further complexing component.

The solid which has been isolated and optionally washed is then dried, optionally after pulverization, at a temperature of, for example, 20 to 100° C. and under a pressure of, for example, 0.1 mbar to normal pressure (1013 mbar).

A suitable method for isolating the DMC catalyst from the suspension by filtration, washing of the filter cake and drying is described in WO-A 01/80994.

In certain embodiments of preparing the polyoxyalkyelene polyols used to make the alkoxysilane-group modified polyurethanes of the present invention, the DMC catalyst is used in an amount of 10 to 1,000 ppm, such as 15 to 500 ppm, 20 to 300 ppm or, in some cases, 25 to 150 ppm, based on the size of the total reaction batch.

In certain embodiments, the DMC catalyst remains in the end product, but it can also be separated off, for example by treatment with adsorbents. Such processes for separating off DMC catalysts are described, for example, in U.S. Pat. No. 4,987,271, DE-A 3132258, EP-A 406440, U.S. Pat. No. 5,391,722, U.S. Pat. No. 5,099,075, U.S. Pat. No. 4,721,818, U.S. Pat. No. 4,877,906 and EP-A 385619.

In certain embodiments, an alkylene oxide (epoxide) having 2 to 24 carbon atoms is employed to prepare the polyoxyalkyelene polyols used to make the alkoxysilane-group modified polyurethanes of the present invention. In certain embodiments, the alkylene oxide comprises ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, a mono- or polyepoxidized fat as a mono-, di- or triglyceride, an epoxidized fatty acid, a C₁-C₂₄ ester of an epoxidized fatty acid, epichlorohydrin, glycidol, a derivative of glycidol, such as, for example, methyl glycidyl ether, ethyl glycidyl ether, 2-ethylhexyl glycidyl ether, allyl glycidyl ether, glycidyl methacrylate, or an epoxide-functional alkyloxysilane, such as, for example, 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane and 3-glycidyloxypropyltriisopropoxysilane, as well as mixtures of two or more of any of the foregoing alkylene oxides.

In certain embodiments, the alkylene oxide comprises propylene oxide and/or ethylene oxide, such as pure propylene oxide or a mixture of propylene oxide and ethylene oxide with up to 75 wt. % of ethylene oxide, based on the total weight of the alkylene oxides metered in. The alkylene oxides can be fed to the reactor as individual components or as a mixture. It is likewise possible to feed several alkylene oxides to the reactor in succession, by which means polyether chains with a block structure can be realized. If several alkylene oxides are metered in, the composition of the alkylene oxide stream fed in can be changed continuously or instantaneously.

Other monomers that can be copolymerized with alkylene oxides under DMC catalysis are, for example, lactones, lactides, acid anhydrides, cyclic carbonates and carbon dioxide.

Anti-ageing agents, such as e.g. antioxidants, can likewise be added to the end products.

In certain embodiments of preparing the polyoxyalkyelene polyols used to make the alkoxysilane-group modified polyurethanes of the present invention, DMC catalyst is added to the starter compound and the mixture is introduced into a reactor, or the starter compound and the DMC catalyst are introduced into a reactor Small amounts (1 to 500 ppm) of organic or inorganic acids can moreover additionally be added to the starter compound before the addition of the DMC catalyst.

In certain embodiments, the contents of the reactor are first stripped with inert gas (nitrogen or a noble gas, such as, for example, argon) at a temperature of 60 to 160° C., such as 100 to 155° C., or, in some cases, 110 to 155° C., over a period of from, for example, 10 to 60 min, while stirring. During the stripping, volatile constituents are removed while passing inert gases into the liquid phase with a simultaneously applied vacuum under an absolute pressure of from, for example, 5 to 500 mbar. The temperature can then be adjusted to the reaction temperature of the following step, if this is not identical to the stripping temperature. However, the final reaction temperature can also first be established in the initial phase of the metering of alkylene oxide. The reaction temperature in the polymerization is, for example, 110 to 150° C., such as 130 to 150° C. or, in some cases, 140 to 150° C.

In certain embodiments, therefore, the polyoxyalkyelene polyols used to make the alkoxysilane-group modified polyurethanes of the present invention, are prepared by a process in which (a) DMC catalyst and one or more starter compounds are initially introduced into a reactor and, at a temperature of from 60 to 160° C., such as 100 to 155° C., or, in some cases, 110 to 155° C., inert gas (nitrogen or a noble gas, such as, for example, argon) is, in some embodiments, passed into the mixture of DMC catalyst and one or more starter compounds and a reduced pressure (absolute) of from 5 mbar to 500 mbar, such as 40 mbar to 200 mbar, is simultaneously established in the reactor by removal of the inert gas (“stripping”); and (b) one or more alkylene oxides are then metered into the reactor over a period of from 15 to 23 hours at, for example, a temperature of 110 to 150° C., such as 130 to 150° C., or, in some cases, 140 to 150° C.

In certain of these embodiments, the DMC catalyst is first activated separately in a process step prior to the polymerization (step (b) above) by metering in 2 to 20 wt. %, based on the sum of the one or more starter compounds employed in step (a). The addition of one or more alkylene oxides can take place before, during or after the heating of the contents of the reactor to the stripping or reaction temperature. After interruption of the metering of alkylene oxide, after typically 2 to 20 wt. % of alkylene oxide, based on the sum of the one or more starter compounds employed in step (a), has been metered in, the activation of the DMC catalyst manifests itself by an accelerated drop in the reactor pressure, whereby the start of the alkylene oxide conversion is indicated. The remaining amount of alkylene oxide or alkylene oxide mixture is then fed continuously to the reaction mixture over a period of from 15 to 23 hours at a reaction temperature of from 110 to 150° C., such as 130 to 150° C., or, in some cases, 140 to 150° C.

The reaction temperature during the polymerization (step (b)) can be varied within the aforementioned temperature limits and the one or more alkylene oxides can be fed to the reactor in various ways. For example, metering into the gas phase or directly into the liquid phase, e.g. via an immersed tube, or a distributor ring located in a thoroughly mixed zone close to the reactor base, is possible. In the case of metering into the liquid phase, the metering systems are often self-emptying in configuration, for example by attachment of the metering bores to the under-side of the distributor ring. In certain embodiments, the alkylene oxides are fed continuously to the reactor such that the safety pressure limits of the reactor system used are not exceeded. In particular, in the case of metering of alkylene oxide mixtures containing ethylene oxide or pure ethylene oxide it typically is to be ensured that an adequate inert gas partial pressure is maintained in the reactor during the start-up and metering phase. This can be established, for example, by a noble gas (such as, for example, argon) or nitrogen. The metering rate of the alkylene oxides in the polymerization phase (step (b)) can be kept constant or alternatively changed stepwise or continuously. For example, the alkylene oxide metering rate in the polymerization phase (step (b)) can be between 4,500 gram of alkylene oxide/(mole of hydroxyl groups×hours) and 50 gram of alkylene oxide/(mole of hydroxyl groups×hours), such as between 2,000 gram of alkylene oxide/(mole of hydroxyl groups×hours) and 50 gram of alkylene oxide/(mole of hydroxyl groups×hours), or, in some cases, 1,000 gram of alkylene oxide/(mole of hydroxyl groups×hours) to 70 gram of alkylene oxide/(mole of hydroxyl groups×hours), and, in yet other cases, between 750 gram of alkylene oxide/(mole of hydroxyl groups×hours) and 100 grams of alkylene oxide/(mole of hydroxyl groups×hours), it being possible for the alkylene oxide metering rate to be kept constant or changed stepwise or continuously. The alkylene oxide metering rate can be both increased and lowered during a reaction batch. In some embodiments, the alkylene oxide metering rate is lowered during a reaction batch.

A reverse flow of reaction medium into the metering systems can advantageously be prevented by apparatus measures, for example by installing nonreturn valves.

If several alkylene oxides are metered in during the polymerization step, the particular alkylene oxides can be fed to the reactor separately or as an alkylene oxide mixture. Mixing of the alkylene oxides can be achieved, for example, by a mixing system located in the common metering zone (“inline blending”). It can also be suitable to meter in the alkylene oxides individually or as a premix or mixture on the pump pressure side in a pumped circulation led, for example, over heat exchangers. For thorough mixing with the reaction medium, it may be desirable to integrate a high-shear mixing system into the alkylene oxide/reaction medium stream. The temperature of the exothermic polymerization (alkylene oxide addition reaction) can be kept at the desired level or adjusted to the desired level by cooling. Such a cooling can be carried out, for example, via the reactor wall (e.g. double-walled jacket, half pipe coil jacket) and/or by means of further heat exchanger surfaces arranged internally in the reactor and/or externally in the pumped circulation, e.g. on cooling coils, cooling cartridges, plate, tube bundle or mixer heat exchangers. Often, these are configured such that cooling can also be carried out effectively at the start of the metering phase, i.e. at a low level of fill.

It is sometimes desirable to ensure thorough mixing of the contents of the reactor in all the reaction phases by configuration and use of stirring units. For example, a mixing energy which is introduced on average over the entire contents of the reactor and is in the range of from 0.2 to 5 W/l, with correspondingly higher local power inputs in the region of the stirring units themselves and where appropriate at lower filling levels, can be useful. To achieve optimum stirring, combinations of baffles (e.g. flat or tubular baffles) and cooling coils (or cooling cartridges) can be arranged in the reactor, and can also extend over the container base. The stirring output of the mixing system can also be varied during the metering phase as a function of the filling level, in order to ensure a particularly high introduction of energy in critical reaction phases. It may also be desirable that the stirrer geometry contribute towards reducing foaming of reaction products. Stirring units which achieve a continuous mixing of the surface of the liquid can be suitable. Depending on the requirement, the stirrer shaft may be base-mounted and may have further support mountings in the container. The stirrer shaft can be driven here from the top or bottom (with a central or eccentric arrangement of the shaft).

It is also possible to achieve the necessary mixing exclusively via a pumped circulation led to a heat exchanger or to operate this as a further mixing component in addition to the stirring system, the contents of the reactor being pumped in circulation as required (such as once to 50 times per hour).

The end of the metering of alkylene oxide can be followed by an after-reaction phase in which the decrease in the concentration of unreacted alkylene oxide can be quantified by monitoring the pressure. If appropriate, after the end of the after-reaction phase the reaction mixture can be freed quantitatively from small amounts of unreacted alkylene oxide, for example, under an absolute pressure of from 1 to 500 mbar, or by stripping. By stripping, volatile constituents, such as, for example, (residual) alkylene oxides, are removed while passing inert gases or steam into the liquid phase with a simultaneously applied vacuum (for example by passing inert gas through under an absolute pressure of from 5 to 500 mbar). The removal of volatile constituents, such as, for example, unreacted alkylene oxides is often carried out at a temperature of 20 to 200° C., such as 50 to 160° C., and, in some cases, at the reaction temperature, while stirring. Such stripping operations can also be carried out in stripping columns, in which a stream of inert gas or steam is passed in counter-current to the product stream. When a constant pressure is reached or when volatile constituents have been removed by vacuum and/or stripping, the product can be discharged from the reactor.

DMC catalysts are sensitive to polar impurities of the reaction mixture, in particular the starter compound(s). The DMC catalysts then cannot be converted or at least can be converted less effectively into the polymerization-active form during the reaction initiation phase. Impurities can be, for example, water or compounds with basic groups, such as, for example, amines. Substances with carbonyl groups in the near vicinity or carbonyl groups adjacent to hydroxyl groups can also have an adverse effect on the catalyst activity. In order to be able nevertheless to subject starters with impurities which are to be regarded as catalyst poisons to DMC-catalyzed alkylene oxide addition reactions, it is often desirable to keep the stationary concentration of catalyst poisons as low as possible. This can be achieved by a process with a continuous metering of the starter compound(s). In this, for example, not the complete amount of starter compounds is initially introduced into the reactor, but only a part, for example 0.1 to 20 percent by weight, of the total amount of starter compound employed, and the remaining amount of starter compound is fed continuously to the reactor together with the alkylene oxides during the reaction (step (b)). The starter compound initially introduced into the reactor is also called the starting medium. A starter compound which is the same as or different from the starter compound employed in step (b) can be employed as the starting medium, specific examples of which include, for example, polyether polyols with equivalent molecular weights in the range of from 56 to 20,000 g/mol, such as 4,000 to 20,000 g/mol, for example a polyether polyol prepared by the process according to the invention, which has been prepared, for example, in a preceding batch, may be used as the starting medium.

In the preparation of the polyoxyalkylene polyols used to make the alkoxysilane-group modified polyurethanes of the present invention, in the case where starter compounds with equivalent molecular weights of less than 200 g/mol are used, it may be desirable to keep the starter metering rate exactly equal to or less than 2.5% of the alkylene oxide metering rate. For this, in some cases, the metering of the starter compound(s) with an equivalent molecular weight of less than 200 g/mol is often carried out as a solution in an inert solvent or as a mixture with a further H-functional starter compound with an equivalent molecular weight of greater than 300 g/mol.

In certain embodiments, a starting medium and DMC catalyst are initially introduced into the reactor system, the DMC catalyst may be activated, and the starter compound(s) is or are fed in continuously together with one or more alkylene oxides within a period of from 15 to 23 hours. It may be desirable for the starter compound(s) to be fed in as a solution in an inert solvent or as a mixture with a further starter compound with an equivalent molecular weight of greater than 300 gram/mole. As indicated, the metering time for the amount of one or more alkylene oxide(s) added in the polymerization step is 15 to 23 hours. Alkylene oxide addition products, such as, for example, polyether polyols with an equivalent molecular weight of 56 to 20,000 gram/mole, such as 190 to 20,000 gram/mole, or from 4,000 to 40,000 gram/mole, such as a polyether polyol prepared by the process described herein, which has been prepared, for example, in a preceding batch, are suitable as the starting medium. In certain embodiments, a part amount of starter compound or polyether polyol with an equivalent molecular weight of from 8,000 to 20,000 g/mol which has been prepared by the process described herein, for example, in a preceding batch, is employed as the starting medium.

In certain embodiments, the metering of the starter compound ends before the metering of the alkylene oxides extending over a period of from 15 to 23 hours is ended. This has the advantage that a complete conversion of the starter compound with the alkylene oxide(s) is achieved. In the context of the process described herein, “concluding phase of the polymerization step” means the period of time from the end of the metering of the starter compound(s) to the end of the metering of the alkylene oxides. In this embodiment, the metering rate of the alkylene oxides can be changed stepwise or continuously in the concluding phase of the polymerization step after the end of the metering of the starter compound(s). For example, the alkylene oxide metering rate can be varied from 4,500 grams of alkylene oxide/(mol of hydroxyl groups×hours) to 50 grams of alkylene oxide/(mol of hydroxyl groups×hours), such as 2,000 grams of alkylene oxide/(mol of hydroxyl groups×hours) to 50 grams of alkylene oxide/(mol of hydroxyl groups×hours), or, in some cases, 1,000 grams of alkylene oxide/(mol of hydroxyl groups×hours) to 70 grams of alkylene oxide/(mol of hydroxyl groups×hours), or, in yet other cases, 750 grams of alkylene oxide/(mol of hydroxyl groups×hours) to 100 grams of alkylene oxide/(mol of hydroxyl groups×hours), the parameter “mol of hydroxyl groups” relating to the substance amount of hydroxyl groups present in the reaction mixture at the time of the end of the metering of the starter compound(s). The alkylene oxide metering rate can be both increased and lowered during the concluding phase of the polymerization step. Alternatively, the alkylene oxide can also be changed after the end of the metering of the starter compound, whereby polyether polyols with multiblock structures can be prepared. It is also possible to end the metering of the starter compound and the alkylene oxide metering simultaneously. It is likewise possible to vary the ratio of the metering rates of the one or more starter compounds and the one or more alkylene oxides during the common metering of the starter compound(s) and the alkylene oxide(s). In some embodiments, the ratio of the alkylene oxide metering rate (M_{A})/metering rate of the H-functional starter compound (M_{H}) fulfils the following inequality in all phases of the common metering phase: (M_{H}×OH number_{starter compound})/(M_{H}+M_{A})≧OH number_{end product}.

After the reagents have been metered in, an after-reaction phase can follow, in which the consumption of alkylene oxide in general can be quantified by monitoring the pressure. When a constant pressure is reached, the product can be discharged.

In certain embodiments, the reaction product is removed from the reactor continuously. In this procedure, a starting medium and a part amount of DMC catalyst are initially introduced into the reactor system and one or more starter compounds with equivalent molecular weights of 18 to 2,000 g/mol, such as 56 to 1,200 g/mol, are fed to the reactor system continuously together with one or more alkylene oxides and DMC catalyst. The reaction product is removed from the reactor system continuously after an average dwell time of from 15 to 23 hours. In certain embodiments, it is removed from the section of the reactor system into which one or more alkylene oxides are also metered. Starter compounds with an equivalent molecular weight of from 150 to 2,000 g/mol are suitable, for example, as the starting medium of this completely continuous polyether polyol preparation process. Alkylene oxide addition products (such as, for example, polyether polyols) and/or a polyether polyol prepared by the process described herein, which has been prepared, for example, in a preceding production campaign, are suitable in particular as the starting medium. In certain embodiments, a polyether polyol prepared by the process described herein, which has been prepared, for example, in a preceding production campaign, is employed as the starting medium. In another suitable procedure, a part amount of starter compound with an equivalent molecular weight of from 150 to 2,000 g/mol and a part amount of DMC catalyst are initially introduced into the reactor system and the remaining part amount of the one or more starter compounds with an equivalent molecular weight of from 150 to 2,000 g/mol are fed to the reactor system continuously together with one or more alkylene oxides and DMC catalyst, the reaction product being removed from the reactor system continuously after an average dwell time of from 15 to 23 hours, and the removal of the reaction product taking place from the section of the reactor system into which one or more alkylene oxides are also metered.

This continuous procedure described above can be followed by continuous after-reaction steps, for example in a reactor cascade or in a tube reactor. Volatile constituents can be removed, as described above. The various process variants in the preparation of polyether polyols by the alkylene oxide addition process under DMC catalysis are described, for example, in WO-A 97/29146 and WO-A 98/03571.

Suitable processes for producing polyoxyalkylene polyols, such as diols, that are suitable for producing the alkoxysilane-groups modified polyurethanes of the present invention are described in U.S. Patent Application Publication No. 2014/0142344 A1 at [0009]-[0095], the cite portion of which being incorporated herein by reference.

In certain embodiments, the polyoxyalkylene polyol, such as diol, that is used for producing the alkoxysilane-group modified polyurethanes of the present invention has a degree of unsaturation of y, wherein y>0.9/(x−10), in which x is the hydroxyl value of the polyoxyalkylene polyol (mg KOH/gram). In certain embodiments, the polyoxyalkylene polyol, such as diol, that is used for producing the alkoxysilane-group modified polyurethanes of the present invention does not itself comprise urethane units.

Polyoxyalkylene polyols, such as diols, that are suitable for use in the preparation of the alkoxysilane-group modified polyurethanes of the present invention are also commercially available, a specific example of which is ACCLAIM® 18200 N, from Bayer MaterialScience.

As indicated, the alkoxysilane-group modified polyurethanes of the present invention are the reaction product of a polyoxyalkylene polyol, such as a diol, as described above; and a compound of the formula: ONC—Y—Si—(X)₃, wherein: (i) each X independently represents identical or different alkoxy radicals, such as wherein each X is, independently of one another, a linear, cyclic or branched C₁-C₈ alkyl or C₁-C₈ alkoxy radical, wherein at least one of the radicals is a C₁-C₈ alkoxy groups, and each X is optionally, independently of one another, bridged, and (ii) Y represents a difunctional organic radical, such as a straight-chain, branched or cyclic alkylene radical having 1 to 8 carbon atoms. In some embodiments, each X is, independently of one another, a methoxy or ethoxy groups and Y is a methylene or propylene radical.

Any monoisocyanate containing alkoxysilane groups is suitable for use in the present invention. Examples of such compounds are isocyanatomethyl trimethoxysilane, isocyanatomethyl triethoxysilane, (isocyanatomethyl)methyl dimethoxysilane, (isocyanatomethyl)methyl diethoxysilane, 3-isocyanatopropyl trimethoxysilane, 3-isocyanatopropyl methyl dimethoxysilane, 3-isocyanatopropyl triethoxysilane and 3-isocyanatopropyl methyl diethoxysilane, as well as mixtures of two or more thereof. It is also possible to use isocyanate-functional silanes produced by reacting a diisocyanate with an aminosilane or thiosilane, as described, for example, in U.S. Pat. No. 4,146,585 or EP-A 1 136 495. In certain embodiments, only one monoisocyanate containing alkoxysilane groups is used in the urethane forming reaction to form the alkoxysilane-group modified polyurethanes of the present invention.

In the alkoxysilane-group modified polyurethanes of the present invention, a weight average molar ratio of isocyanate groups of compound (2) to hydroxyl groups of compound (1) used to make the polyurethane is less than 0.80:1, such as no more than 0.76:1, in some cases 0.5 to 0.76:1, or, in yet other cases 0.6 to 0.76:1. The alkoxysilane-group modified polyurethanes of the present invention may, in certain embodiments, be a mixture of two or more different alkoxysilane-group modified polyurethanes in which the molar ratio isocyanate groups of compound (2) to hydroxyl groups of compound (1) used to make the polyurethanes differs from each other, as such, “weight average molar ratio” refers to the weighted average molar ratio of isocyanate groups to hydroxyl groups used in the mixture.

The urethane reaction of compounds (1) and (2) can be performed with the use of a catalyst. Suitable catalysts include organotin compounds or amine catalysts, specific examples of which include, but are not limited to, dibutyl tin diacetate, dibutyl tin dilaurate, dibutyl tin bis-acetoacetonate and tin carboxylates such as for example tin octoate, aminosilanes or 1,4-diazabicyclo[2.2.2]octane.

In certain embodiments, the reaction is performed until a complete reaction of the NCO groups is achieved.

In certain embodiments, the alkoxysilane-group-modified polyurethanes of the present invention have a viscosity of less than 200,000 mPas, such as less than 100,000 mPas, measured at 23° C.

In certain embodiments, the viscosity of the alkoxysilane group-modified polyurethanes of the present invention is adjusted by combination of the polyurethane with a polyol or monoalcohol. In certain embodiments, for example, the alkoxysilane-group-modified polyurethane is combined with a linear, branched or cyclic monoalcohol containing 1 to 5, such as 2 to 5 or 3 to 5 carbon atoms, specific examples of which include, but are not limited to, methanol, ethanol, n-propanol, isopropanol, n-butanol, isobutanol and tert-butanol, n-pentanol, 2-hydroxy pentane, 3-hydroxy pentane, the isomeric methyl butyl alcohols, the isomeric dimethyl propyl alcohols, neopentyl alcohol, ethoxy methanol, methoxy ethanol, ethoxy ethanol, the isomeric methoxy or ethoxy propanols, the isomeric propoxy methanols and ethanols, the isomeric methoxy butanols, the isomeric butoxy methanols and furfuralcohol. In certain embodiments, a polymeric monoalcohol is used, such as a polyether monols having an equivalent weight of at least 100, at least 250, or at least 1000 and/or up to about 10,000, such as up to 7000 or up to 4500. As used herein, the term polyether monol refers to compounds of the above specified equivalent weight range which have a theoretical functionality ranging from about 1.0 to about 1.2. As will be appreciated, suitable polyether monols can be prepared by condensing an alkylene oxide or a mixture of alkylene oxides using random or step-wise addition, with a hydric initiator or a mixture of such initiators. In certain embodiments, the polyol or monoalcohol is utilized in an amount of at least 0.5 percent by weight, such as at least 10 percent by weight, and up to 50 percent by weight, based on the total weight of the alkoxysilane group-modified polyurethane.

The alkoxysilane-group modified polyurethanes described herein can be particularly suitable for use as the main binder resin in sealant compositions. In certain embodiments, the alkoxysilane-group modified polyurethane is present in such a composition in an amount of at least 10 percent by weight, such as at least 20 percent by weight or at least 25 percent by weight and/or up to 50 percent by weight, such as up to 40 percent by weight or up to 35 percent by weight, based on the total weight of the composition.

In certain embodiments, the compositions of the present invention may further include fillers, inert plasticizers, pigments, driers, additives, light stabilizers, antioxidants, thixotropic agents, catalysts, silane adhesion promoters and, where appropriate, further auxiliaries and additives in accordance with known methods of producing sealants.

Sealant compositions of the present invention may, if desired, contain a filler. For example, in some cases, a filler, such as calcium carbonate and/or titanium dioxide, is present in the composition of the present invention in an amount of up to 10 percent by weight. In other embodiments, a filler may be present in an amount of at least 10 percent by weight, such as at least 20 percent by weight, at least 25 percent by weight, or in some cases, at least 30 percent by weight and/or up to 70 percent by weight, such as up to 60 percent by weight, or, in some cases, up to 50 percent by weight, the weight percents being based on the total weight of the composition.

Examples of other suitable fillers for use in the inventive sealant compositions include carbon black, precipitated hydrated silicas, mineral chalk materials and precipitated chalk materials. In certain embodiments, fillers used in the compositions of the present invention consist of inorganic fillers.

Examples of suitable inert plasticizers include, but are not limited to, phthalic acid esters, adipic acid esters, alkylsulphonic acid esters of phenol, or phosphoric acid esters. As used herein, “inert plasticizer” means an organic liquid or solid that is incorporated into the formulation with the alkoxysilane-group-modified polyurethane base resin described herein to reduce interaction between molecules and improve molecular mobility, thereby making the resin more flexible and which is inert to the base resin. In certain embodiments, however, the compositions of the present invention comprise no more than 15 percent by weight, such as no more than 5 percent by weight, no more than 2 percent by weight, of such plasticizer. In certain embodiments, in fact, the compositions of the present are substantially free or completely free of such plasticizer. As used herein, “substantially free” when used with reference to the absence of plasticizer in the composition, means that no plasticizer is intentionally added to the composition. Nevertheless, in certain embodiments, these compositions, which contain no more than 15 percent by weight plasticizer and, in some cases, are substantially free or completely free of plasticizer, still provide a cured sealant that has modulus at 100% extension of no more than 60 pounds per square inch, such as 20 pounds per square inch (0.14 MPa) to 60 pounds per square inch (0.41 MPa), when measured according to ASTM D412, Method A.

Examples of thixotropic agents include pyrogenic hydrated silicas, polyamides, products derived from hydrogenated castor oil, and also polyvinyl chloride.

The sealant compositions of the present invention can be used for the joining and sealing of materials made, for example, from metal, ceramic, glass, plastic, wood, concrete and other construction materials. In some embodiments, the compositions of the present invention may be used to seal an aperture (i.e., a gap) by depositing the composition over at least a portion of the aperture and allowing the composition to cure to seal the aperture. Such apertures may be present within a single substrate or between two or more different substrates. The compositions may be applied over an aperture or onto surfaces using various techniques, however, in certain embodiments, the composition is applied by use of a 1-component caulking gun of the type familiar to those skilled in the art. Such apertures may be found, for example, at a joint in a structure, such as an expansion joint, a control joint, or a perimeter joint.

It has been discovered, surprisingly, that by using the alkoxysilane-group modified polyurethanes described as the main binder resin in a sealant composition it is possible to produce a low modulus cured sealant (modulus at 100% elongation of no more than 60 pounds per square inch (0.41 MPa)) while utilizing no more than 15 percent by weight plasticizer and, in some cases, none or substantially no plasticizer, in the composition, while still providing a sealant that exhibits acceptable tensile, elongation, tear resistance, and Shore A hardness properties.

Thus, in certain embodiments, in addition to the 100% modulus described above. Sealants formed from the compositions of the present invention can, in at least some cases, exhibit a desirable combination of other properties. For example, in some embodiments, sealants formed from the compositions of the present invention have (i) an ultimate tensile strength of 50 to 300 pounds per square inch (0.34 to 2.07 MPa), such as 50 to 250 pounds per square inch (0.34 to 1.72 MPa), such as 100 to 200 pounds per square inch (0.69 to 1.38 MPa) or 100 to 150 pounds per square inch (0.69 to 1.03 MPa); (ii) a breaking elongation of >50%, such as >300%, such as greater than 400% or greater than 500%; (iii) a tear resistance of at least 15 pounds per linear inch (at least 2.68 kilogram per linear centimeter), such as 15 to 60 pounds per linear inch (2.68 to 10.72 kilogram per linear centimeter) or 30 to 40 pounds per linear inch (5.36 to 7.14 kilogram per linear centimeter); and/or (iv) a Shore A hardness (at 1 second and 5 seconds) of 5 to 30, such as 9 to 22. In the present invention, tensile strength and breaking elongation can be determined according to ASTM D412, Method A, tear resistance can be determined by ASTM D624, Die “C”, and Shore A hardness according to ASTM D-2240.

As will be appreciated from the foregoing description, certain embodiments of the present invention are directed to alkoxysilane-group modified polyurethanes that are the reaction product of: (1) a polyoxyalkylene polyol having a molecular weight of at least 18,000 gram/mole and a content of unsaturated end groups of no more than 0.02 meq/gram polyol, measured according to ASTM D2849-69; and (2) a compound of the formula: ONC—Y—Si—(X)₃, wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80:1.

In certain embodiments, the present invention is directed to an alkoxysilane-group modified polyurethane of the immediately previous paragraph, wherein the polyoxyalkyelene polyol comprises a diol.

In some embodiments, the present invention is directed to an alkoxysilane-group modified polyurethane of either of the immediately preceding two paragraphs, wherein the polyoxyalkylene polyol, such as diol, has a molecular weight of greater than 20,000 gram/mole, in some cases as at least 21,000 gram/mole, in some cases at least 22,000 gram/mole and/or in some cases up to 30,000 gram/mole or, in some cases, up to 25,000 grain/mole.

In certain embodiments, the present invention is directed to an alkoxysilane-group modified polyurethane of any of the immediately preceding three paragraphs, wherein the polyoxyalkyelene polyol, such as diol, used to make the alkoxysilane-group modified polyurethane has a polydispersity of less than 1.5, in some cases 1.0 to 1.3 or, in some cases, 1.05 to 1.15.

In certain embodiments, the present invention is directed to an alkoxysilane-group modified polyurethane of any of the immediately preceding four paragraphs, wherein the polyoxyalkyelene polyol, such as diol, used to make the alkoxysilane-group modified polyurethane has a content of unsaturated end groups of no more than no more than 0.01 meq/gram polyol or 0.008 to 0.01 meq/gram polyol.

Some embodiments of the present invention are directed to an alkoxysilane-group modified polyurethane of any of the immediately preceding five paragraphs, wherein the polyoxyalkylene polyol, such as diol, used to make the alkoxysilane-group modified polyurethane is obtained by alkoxylation of a starter molecule with the use of a DMC catalyst.

In some embodiments, the present invention is directed to an alkoxysilane-group modified polyurethane of any of the immediately preceding six paragraphs, in which the polyoxylkylene polyol has, on average, 1.5 to 3.5, such as 1.8 to 2.5, such as 2, hydroxyl groups, per molecule.

In certain embodiments, the present invention is directed to an alkoxysilane-group modified polyurethane of any of the immediately preceding seven paragraphs, in which the polyoxylkylene polyol, such as diol, is prepared by a process in which an alkylene oxide is metered into a reactor over a period of from 15 to 23 hours. In some of these embodiments, the polyoxyalkylene polyol, such as diol, is obtained by alkoxylation of a starter molecule with the use of a DMC catalyst, in which the starter compound has 1 to 8, or, 2 to 3 or 2 hydroxyl groups per molecule and/or has a molecular weight of from 18 gram/mole to 1,200 gram/mole and/or is a polyether polyol, such as a polyether diol, with an OH number of from 16 to 1,000 mg of KOH/g, such as 40 to 1,000 mg of KOH/g. In some of these embodiments, an alkylene oxide (epoxide) having 2 to 24 carbon atoms is employed to prepare the polyoxyalkyelene polyol, such as propylene oxide and/or a polyether polyol with an equivalent molecular weight of from 8,000 to 20,000 g/mol.

In certain embodiments, the present invention is directed to an alkoxysilane-group modified polyurethane of any of the immediately preceding eight paragraphs, in which the polyoxyalkylene polyol, such as diol, that is used for producing the alkoxysilane-group modified polyurethane has a degree of unsaturation of y, wherein y>0.9/(x−10), in which x is the hydroxyl value of the polyoxyalkylene polyol (mg KOH/gram).

In certain embodiments, the present invention is directed to an alkoxysilane-group modified polyurethane of any of the immediately preceding ten paragraphs, in which the polyoxyalkylene polyol, such as diol, that is used for producing the alkoxysilane-group modified polyurethanes of the present invention does not itself comprise urethane units.

Certain embodiments of the present invention are directed to an alkoxysilane-group modified polyurethane of any of the immediately preceding eleven paragraphs, in which (i) each X is, independently of one another, a linear, cyclic or branched C₁-C₈ alkyl or C₁-C₈ alkoxy radical, wherein at least one of the radicals is a C₁-C₈ alkoxy groups, and each X is optionally, independently of one another, bridged, and (ii) Y represents a straight-chain, branched or cyclic alkylene radical having 1 to 8 carbon atoms, such as where each X is, independently of one another, a methoxy or ethoxy groups and Y is a methylene or propylene radical, such as where compound (2) comprises isocyanatopropyl trimethoxysilane.

In some embodiments, the present invention is directed to an alkoxysilane-group modified polyurethane of any of the immediately preceding twelve paragraphs, in which only one compound (2) is used.

In certain embodiments, the present invention is directed to an alkoxysilane-group modified polyurethane of any of the immediately preceding thirteen paragraphs, in which the weight average molar ratio of isocyanate groups of compound (2) to hydroxyl groups of compound (1) used to make the polyurethane is no more than 0.76:1, or 0.5 to 0.76:1 or 0.6 to 0.76:1.

Some embodiments of the present invention are directed to an alkoxysilane-group modified polyurethane of any of the immediately preceding fourteen paragraphs, in which the alkoxysilane-group-modified polyurethane has a viscosity of less than 200,000 mPas or less than 100,000 mPas, measured at 23° C.

In some embodiments, the present invention is directed to a composition comprising an alkoxysilane-group modified polyurethane of any of the immediately preceding fifteen paragraphs and a polyol or monoalcohol, such as a linear, branched or cyclic monoalcohol containing 1 to 5, such as 2 to 5 or 3 to 5 carbon atoms and/or a polymeric monoalcohol, such as a polyether monol having an equivalent weight of at least 100, at least 250, or at least 1000 and/or up to about 10,000, such as up to 7000 or up to 4500. In certain embodiments of these embodiments, the polyol or monoalcohol is utilized in an amount of at least 0.5 percent by weight, such as at least 10 percent by weight, and up to 50 percent by weight, based on the total weight of the alkoxysilane group-modified polyurethane.

Some embodiments of the present invention are directed to a sealant composition comprising an alkoxysilane-group modified polyurethane of any of the immediately preceding sixteen paragraphs in which the alkoxysilane-group modified polyurethane is present in such a composition in an amount of 10 to 50 percent by weight, such as 20 to 40 percent by weight or 25 to 35 percent by weight, based on the total weight of the composition. In some of these embodiments, the composition further comprises a filler, such as calcium carbonate and/or titanium dioxide, that is present in the composition in an amount of up to 10 percent by weight or in an amount of at least 10 percent by weight or at least 20 percent by weight or at least 25 percent by weight or at least 30 percent by weight and/or up to 70 percent by weight or 60 percent by weight or up to 50 percent by weight, the weight percents being based on the total weight of the composition. In addition, in some of the embodiments of the present invention of this paragraph, the composition comprises no more than 15 percent by weight or no more than 5 percent by weight or no more than 2 percent by weight, of inert plasticizer or, in some cases, the composition is substantially free or completely free of such plasticizer and the composition provides a cured sealant that has modulus at 100% extension of no more than 60 pounds per square inch (0.41 MPa), such as 20 to 60 pounds per square inch (0.14 to 0.41 MPa), when measured according to ASTM D412, Method A. Some of these cured sealants also have (i) an ultimate tensile strength of 50 to 300 pounds per square inch, such as 50 to 250 pounds per square inch, such as 100 to 200 pounds per square inch or 100 to 150 pounds per square inch; (ii) a breaking elongation of >50%, such as >300%, such as greater than 400% or greater than 500%; (iii) a tear resistance of at least 15 pounds per linear inch, such as 15 to 60 pounds per linear inch or 30 to 40 pounds per linear inch; and/or (iv) a Shore A hardness (at 1 second and 5 seconds) of 5 to 30, such as 9 to 22. Some embodiments of the present invention are directed to methods of using a composition described in this paragraph to join and seal a material made from metal, ceramic, glass, plastic, wood, and/or concrete and may be used to seal an aperture (i.e., a gap) by depositing the composition over at least a portion of the aperture and allowing the composition to cure to seal the aperture, in which such an aperture is present within a single substrate or between two or more different substrates and may be found at a joint in a structure, such as an expansion joint, a control joint, or a perimeter joint.

Some embodiments of the present invention are directed to moisture curable compositions comprising: (a) an alkoxysilane-group modified polyurethane comprising a reaction product of: (1) a polyoxyalkylene polyol having a molecular weight of at least 18,000 gram/mole and a content of unsaturated end groups of no more than 0.07 meq/gram polyol, measured according to ASTM D2849-69; and (2) a compound of the formula: ONC—Y—Si—(X)₃, wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80:1; (b) a filler; and (c) 0 to 15% by weight, based on the total weight of the composition, of an inert plasticizer. The present invention is also directed to sealants exhibiting a low modulus formed from such compositions and methods for using such compositions to seal a joint edge of joined substrates.

In some embodiments, the present invention is directed to a moisture curable composition of the immediately preceding paragraph, wherein the polyoxyalkyelene polyol comprises a diol.

In some embodiments, the present invention is directed to a moisture curable composition of either of the immediately preceding two paragraphs, wherein the polyoxyalkylene polyol, such as diol, has a molecular weight of greater than 20,000 gram/mole, in some cases as at least 21,000 gram/mole, in some cases at least 22,000 gram/mole and/or in some cases up to 30,000 gram/mole or, in some cases, up to 25,000 gram/mole.

In certain embodiments, the present invention is directed to a moisture curable composition of any of the immediately preceding three paragraphs, wherein the polyoxyalkyelene polyol, such as diol, used to make the alkoxysilane-group modified polyurethane has a polydispersity of less than 1.5, in some cases 1.0 to 1.3 or, in some cases, 1.05 to 1.15.

In certain embodiments, the present invention is directed to a moisture curable composition of any of the immediately preceding four paragraphs, wherein the polyoxyalkyelene polyol, such as diol, used to make the alkoxysilane-group modified polyurethane has a content of unsaturated end groups of no more than no more than 0.02 meq/gram polyol or no more than 0.01 meq/gram polyol or 0.008 to 0.01 meq/gram polyol.

Some embodiments of the present invention are directed to a moisture curable composition of any of the immediately preceding five paragraphs, wherein the polyoxyalkylene polyol, such as diol, used to make the alkoxysilane-group modified polyurethane is obtained by alkoxylation of a starter molecule with the use of a DMC catalyst.

In some embodiments, the present invention is directed to a moisture curable composition of any of the immediately preceding six paragraphs, in which the polyoxylkylene polyol has, on average, 1.5 to 3.5, such as 1.8 to 2.5, such as 2, hydroxyl groups, per molecule.

In certain embodiments, the present invention is directed to a moisture curable composition of any of the immediately preceding seven paragraphs, in which the polyoxylkylene polyol, such as diol, is prepared by a process in which an alkylene oxide is metered into a reactor over a period of from 15 to 23 hours. In some of these embodiments, the polyoxyalkylene polyol, such as diol, is obtained by alkoxylation of a starter molecule with the use of a DMC catalyst, in which the starter compound has 1 to 8, or, 2 to 3 or 2 hydroxyl groups per molecule and/or has a molecular weight of from 18 gram/mole to 1,200 gram/mole and/or is a polyether polyol, such as a polyether diol, with an OH number of from 16 to 1,000 mg of KOH/g, such as 40 to 1,000 mg of KOH/g. In some of these embodiments, an alkylene oxide (epoxide) having 2 to 24 carbon atoms is employed to prepare the polyoxyalkyelene polyol, such as propylene oxide and/or a polyether polyol with an equivalent molecular weight of from 8,000 to 20,000 g/mol.

In certain embodiments, the present invention is directed to a moisture curable composition of any of the immediately preceding eight paragraphs, in which the polyoxyalkylene polyol, such as diol, that is used for producing the alkoxysilane-group modified polyurethane has a degree of unsaturation of y, wherein y>0.9/(x−10), in which x is the hydroxyl value of the polyoxyalkylene polyol (mg KOH/gram).

In certain embodiments, the present invention is directed to a moisture curable composition of any of the immediately preceding ten paragraphs, in which the polyoxyalkylene polyol, such as diol, that is used for producing the alkoxysilane-group modified polyurethanes of the present invention does not itself comprise urethane units.

Certain embodiments of the present invention are directed to a moisture curable composition of any of the immediately preceding eleven paragraphs, in which (i) each X is, independently of one another, a linear, cyclic or branched C₁-C₈ alkyl or C₁-C₈ alkoxy radical, wherein at least one of the radicals is a C₁-C₈ alkoxy groups, and each X is optionally, independently of one another, bridged, and (ii) Y represents a straight-chain, branched or cyclic alkylene radical having 1 to 8 carbon atoms, such as where each X is, independently of one another, a methoxy or ethoxy groups and Y is a methylene or propylene radical, such as where compound (2) comprises isocyanatopropyl trimethoxysilane.

In some embodiments, the present invention is directed to a moisture curable composition of any of the immediately preceding twelve paragraphs, in which only one compound (2) is used.

In certain embodiments, the present invention is directed to a moisture curable composition of any of the immediately preceding thirteen paragraphs, in which the weight average molar ratio of isocyanate groups of compound (2) to hydroxyl groups of compound (1) used to make the polyurethane is no more than 0.76:1, or 0.5 to 0.76:1 or 0.6 to 0.76:1.

Some embodiments of the present invention are directed to a moisture curable composition of any of the immediately preceding fourteen paragraphs, in which the alkoxysilane-group-modified polyurethane has a viscosity of less than 200,000 mPas or less than 100,000 mPas, measured at 23° C.

In some embodiments, the present invention is directed to a moisture curable composition of any of the immediately preceding fifteen paragraphs, further comprising a polyol or monoalcohol, such as a linear, branched or cyclic monoalcohol containing 1 to 5, such as 2 to 5 or 3 to 5 carbon atoms and/or a polymeric monoalcohol, such as a polyether monol having an equivalent weight of at least 100, at least 250, or at least 1000 and/or up to about 10,000, such as up to 7000 or up to 4500. In certain embodiments of these embodiments, the polyol or monoalcohol is utilized in an amount of at least 0.5 percent by weight, such as at least 10 percent by weight, and up to 50 percent by weight, based on the total weight of the alkoxysilane group-modified polyurethane.

Some embodiments of the present invention are directed to a moisture curable composition of any of the immediately preceding sixteen paragraphs in which the alkoxysilane-group modified polyurethane is present in such a composition in an amount of 10 to 50 percent by weight, such as 20 to 40 percent by weight or 25 to 35 percent by weight, based on the total weight of the composition. In some of these embodiments, the filler, such as calcium carbonate and/or titanium dioxide, is present in the composition in an amount of up to 10 percent by weight or in an amount of at least 10 percent by weight or at least 20 percent by weight or at least 25 percent by weight or at least 30 percent by weight and/or up to 70 percent by weight or 60 percent by weight or up to 50 percent by weight, the weight percents being based on the total weight of the composition. In addition, in some of the embodiments of the present invention of this paragraph, the composition comprises no more than 5 percent by weight or no more than 2 percent by weight, of inert plasticizer or, in some cases, the composition is substantially free or completely free of such plasticizer and the composition provides a cured sealant that has modulus at 100% extension of no more than 60 pounds per square inch (0.41 MPa), such as 20 to 60 pounds per square inch (0.14 to 0.41 MPa), when measured according to ASTM D412, Method A. Some of these cured sealants also have (i) an ultimate tensile strength of 50 to 300 pounds per square inch, such as 50 to 250 pounds per square inch, such as 100 to 200 pounds per square inch or 100 to 150 pounds per square inch; (ii) a breaking elongation of >50%, such as >300%, such as greater than 400% or greater than 500%; (iii) a tear resistance of at least 15 pounds per linear inch, such as 15 to 60 pounds per linear inch or 30 to 40 pounds per linear inch; and/or (iv) a Shore A hardness (at 1 second and 5 seconds) of 5 to 30, such as 9 to 22. Some embodiments of the present invention are directed to methods of using a composition described in this paragraph to join and seal a material made from metal, ceramic, glass, plastic, wood, and/or concrete and may be used to seal an aperture (i.e., a gap) by depositing the composition over at least a portion of the aperture and allowing the composition to cure to seal the aperture, in which such an aperture is present within a single substrate or between two or more different substrates and may be found at a joint in a structure, such as an expansion joint, a control joint, or a perimeter joint.

As will also be appreciated from the foregoing description, embodiments of the present invention are also directed to a cured sealant having a modulus at 100% extension of no more than 60 pounds per square inch when measured according to ASTM D412, Method A, wherein the cured sealant is produced from a composition comprising: (a) an alkoxysilane-group modified polyurethane comprising a reaction product of: (1) a polyoxyalkylene polyol having a molecular weight of at least 18,000 gram/mole and a polydispersity of less than 1.5; and (2) a compound of the formula: ONC—Y—Si—(X)₃, wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80; (b) a filler; and (c) 0 to 15% by weight, based on the total weight of the composition, of an inert plasticizer.

In some embodiments, the present invention is directed to a cured sealant of the immediately preceding paragraph, wherein the polyoxyalkyelene polyol comprises a diol.

In some embodiments, the present invention is directed to a cured sealant of either of the immediately preceding two paragraphs, wherein the polyoxyalkylene polyol, such as diol, has a molecular weight of greater than 20,000 gram/mole, in some cases as at least 21,000 gram/mole, in some cases at least 22,000 gram/mole and/or in some cases up to 30,000 gram/mole or, in some cases, up to 25,000 gram/mole.

In certain embodiments, the present invention is directed to a cured sealant of any of the immediately preceding three paragraphs, wherein the polyoxyalkyelene polyol, such as diol, used to make the alkoxysilane-group modified polyurethane has a polydispersity of less than 1.5, in some cases 1.0 to 1.3 or, in some cases, 1.05 to 1.15.

In certain embodiments, the present invention is directed to a cured sealant of any of the immediately preceding four paragraphs, wherein the polyoxyalkyelene polyol, such as diol, used to make the alkoxysilane-group modified polyurethane has a content of unsaturated end groups of no more than 0.07 meq/gram polyol or no more than 0.02 meq/gram polyol or no more than 0.01 meq/gram polyol or 0.008 to 0.01 meq/gram polyol.

Some embodiments of the present invention are directed to a cured sealant of any of the immediately preceding five paragraphs, wherein the polyoxyalkylene polyol, such as diol, used to make the alkoxysilane-group modified polyurethane is obtained by alkoxylation of a starter molecule with the use of a DMC catalyst.

In some embodiments, the present invention is directed to a cured sealant of any of the immediately preceding six paragraphs, in which the polyoxylkylene polyol has, on average, 1.5 to 3.5, such as 1.8 to 2.5, such as 2, hydroxyl groups, per molecule.

In certain embodiments, the present invention is directed to a cured sealant of any of the immediately preceding seven paragraphs, in which the polyoxylkylene polyol, such as diol, is prepared by a process in which an alkylene oxide is metered into a reactor over a period of from 15 to 23 hours. In some of these embodiments, the polyoxyalkylene polyol, such as diol, is obtained by alkoxylation of a starter molecule with the use of a DMC catalyst, in which the starter compound has 1 to 8, or, 2 to 3 or 2 hydroxyl groups per molecule and/or has a molecular weight of from 18 gram/mole to 1,200 gram/mole and/or is a polyether polyol, such as a polyether diol, with an OH number of from 16 to 1,000 mg of KOH/g, such as 40 to 1,000 mg of KOH/g. In some of these embodiments, an alkylene oxide (epoxide) having 2 to 24 carbon atoms is employed to prepare the polyoxyalkyelene polyol, such as propylene oxide and/or a polyether polyol with an equivalent molecular weight of from 8,000 to 20,000 g/mol.

In certain embodiments, the present invention is directed to a cured sealant of any of the immediately preceding eight paragraphs, in which the polyoxyalkylene polyol, such as diol, that is used for producing the alkoxysilane-group modified polyurethane has a degree of unsaturation of y, wherein y>0.9/(x−10), in which x is the hydroxyl value of the polyoxyalkylene polyol (mg KOH/gram).

In certain embodiments, the present invention is directed to a cured sealant of any of the immediately preceding ten paragraphs, in which the polyoxyalkylene polyol, such as diol, that is used for producing the alkoxysilane-group modified polyurethanes of the present invention does not itself comprise urethane units.

Certain embodiments of the present invention are directed to a cured sealant of any of the immediately preceding eleven paragraphs, in which (i) each X is, independently of one another, a linear, cyclic or branched C₁-C₈ alkyl or C₁-C₈ alkoxy radical, wherein at least one of the radicals is a C₁-C₈ alkoxy groups, and each X is optionally, independently of one another, bridged, and (ii) Y represents a straight-chain, branched or cyclic alkylene radical having 1 to 8 carbon atoms, such as where each X is, independently of one another, a methoxy or ethoxy groups and Y is a methylene or propylene radical, such as where compound (2) comprises isocyanatopropyl trimethoxysilane.

In some embodiments, the present invention is directed to a cured sealant of any of the immediately preceding twelve paragraphs, in which only one compound (2) is used.

In certain embodiments, the present invention is directed to a cured sealant of any of the immediately preceding thirteen paragraphs, in which the weight average molar ratio of isocyanate groups of compound (2) to hydroxyl groups of compound (1) used to make the polyurethane is no more than 0.76:1, or 0.5 to 0.76:1 or 0.6 to 0.76:1.

Some embodiments of the present invention are directed to a cured sealant of any of the immediately preceding fourteen paragraphs, in which the alkoxysilane-group-modified polyurethane has a viscosity of less than 200,000 mPas or less than 100,000 mPas, measured at 23° C.

In some embodiments, the present invention is directed to a cured sealant of any of the immediately preceding fifteen paragraphs, wherein the composition further comprises a polyol or monoalcohol, such as a linear, branched or cyclic monoalcohol containing 1 to 5, such as 2 to 5 or 3 to 5 carbon atoms and/or a polymeric monoalcohol, such as a polyether monol having an equivalent weight of at least 100, at least 250, or at least 1000 and/or up to about 10,000, such as up to 7000 or up to 4500. In certain embodiments of these embodiments, the polyol or monoalcohol is utilized in an amount of at least 0.5 percent by weight, such as at least 10 percent by weight, and up to 50 percent by weight, based on the total weight of the alkoxysilane group-modified polyurethane.

Some embodiments of the present invention are directed to a cured sealant of any of the immediately preceding sixteen paragraphs in which the alkoxysilane-group modified polyurethane is present in the composition in an amount of 10 to 50 percent by weight, such as 20 to 40 percent by weight or 25 to 35 percent by weight, based on the total weight of the composition. In some of these embodiments, the filler, such as calcium carbonate and/or titanium dioxide, is present in the composition in an amount of up to 10 percent by weight or in an amount of at least 10 percent by weight or at least 20 percent by weight or at least 25 percent by weight or at least 30 percent by weight and/or up to 70 percent by weight or 60 percent by weight or up to 50 percent by weight, the weight percents being based on the total weight of the composition. In addition, in some of the embodiments of the present invention of this paragraph, the composition comprises no more than 5 percent by weight or no more than 2 percent by weight, of inert plasticizer or, in some cases, the composition is substantially free or completely free of such plasticizer. Some of these cured sealants also have (i) an ultimate tensile strength of 50 to 300 pounds per square inch, such as 50 to 250 pounds per square inch, such as 100 to 200 pounds per square inch or 100 to 150 pounds per square inch; (ii) a breaking elongation of >50%, such as >300%, such as greater than 400% or greater than 500%; (iii) a tear resistance of at least 15 pounds per linear inch, such as 15 to 60 pounds per linear inch or 30 to 40 pounds per linear inch; and/or (iv) a Shore A hardness (at 1 second and 5 seconds) of 5 to 30, such as 9 to 22.

The non-limiting and non-exhaustive examples that follow are intended to further describe various non-limiting and non-exhaustive embodiments without restricting the scope of the embodiments described in this specification.

### EXAMPLES

Unless otherwise specified, all percentages are to be understood as being percentages by weight.

### Example 1

### Preparation of Alkoxysilane-Group Modified Polyurethanes

In a 5-liter, round bottom flask equipped with an agitator, thermocouple, nitrogen inlet, addition funnel and condenser, 8791.0 g of polypropylene glycol with a hydroxyl value of 5.9 mg KOH/g (Polyol 1, ACCLAIM® Polyol 18200 N, which is a linear polyether diol and a content of unsaturated end groups of no more than 0.02 meq/gram polyol) was mixed with 50 ppm of dibutyl tin dilaurate. After the mixture was heated to 60° C., 190.2 g of isocyanatopropyl trimethoxysilane (TMOSPI) was added. Then, the reaction mixture was prepolymerized until no free NCO could be detected by means of IR spectroscopy. Finally 2000 ppm of vinyl trimethoxy silane and 35 ppm dibutyl phosphate were added to the prepolymer. The so obtained polyurethane prepolymer with alkoxysilane end groups had a viscosity of 39,700 mPas at 23° C.

The same procedure was repeated using different weights of the isocyanatopropyl trimethoxysilane (see Table 1). In SILANES B, C, and D a polypropylene glycol with a hydroxyl value of 4.9 mg KOH/g (Polyol 2, ACCLAIM® Polyol 22200 N, which is a linear polyether diol with a content of unsaturated end groups of no more than 0.02 meq/gram polyol) was used.

TABLE 1

| | Polyol 1 | Polyol 2 | TMOSPI | NCO/ | Viscosity |
|---|---|---|---|---|---|
| Silane | (g) | (g) | (g) | OH | (at 23° C., mPas) |
| SILANE D | 8791.0 | — | 190.2 | 0.9 | 39,700 |
| SILANE E | 8791.0 | — | 169.1 | 0.8 | 39,400 |
| SILANE F | 8791.0 | — | 126.8 | 0.6 | 34,000 |
| SILANE A | — | 8531.6 | 150.3 | 0.9 | 70,200 |
| SILANE B | — | 8548.3 | 133.6 | 0.8 | 67,900 |
| SILANE C | — | 8384.4 | 97.9 | 0.6 | 67,800 |

### Example 2

### Preparation of Sealants

Sealant formulations were prepared using the ingredients and amounts (percent by weight) listed in Table 2. Fillers and plasticizers were placed in a vacuum oven and heated at 60° C. under reduced pressure. All components except the fillers and catalyst were added into a Flack Tech cup, and then placed in a spin mixer for 10 seconds at 2700 rpm. The filler was added and the cup placed back in the Flack Tech mixer and mixed until homogenous. The catalyst was added and the Flack Tech cup was mixed for an additional 10 seconds at 2700 rpm. The sealant composition was drawn down on polypropylene plastic sheets at 100 mils and allowed to cure at room temperature for 7 days.

Once cured, the films were submitted for physical testing. Results of physical testing for the cured films are set forth in Table 2. Tensile strength at break, maximum elongation, and modulus at 100% extension were determined by ASTM D412, Method A. Tear resistances were determined by ASTM D624, Die “C”. Shore A hardness was determined by ASTM D 2240.

TABLE 2

| | 2A | 2B | 2C | 2D | 2E | 2F |
|---|---|---|---|---|---|---|
| SILANE A | 30.80 | — | — | — | — | — |
| SILANE B | — | 30.80 | — | — | — | — |
| SILANE C | — | — | 30.80 | — | — | — |
| SILANE D | — | — | — | 30.80 | — | — |
| SILANE E | — | — | — | — | 30.80 | — |
| SILANE F | — | — | — | — | — | 30.80 |
| MESAMOLL ®¹ | 15.0 | 15.0 | 15.0 | 15.0 | 15.0 | 15.0 |
| ULTRA-PFLEX ®² | 7.50 | 7.50 | 7.50 | 7.50 | 7.50 | 7.50 |
| Atomite ®³ | 12.50 | 12.50 | 12.50 | 12.50 | 12.50 | 12.50 |
| Drikalite ®⁴ | 30.0 | 30.0 | 30.0 | 30.0 | 30.0 | 30.0 |
| TiO₂ | 1.00 | 1.00 | 1.00 | 1.00 | 1.00 | 1.00 |
| CAB-O-SIL ® TS 720⁵ | 1.50 | 1.50 | 1.50 | 1.50 | 1.50 | 1.50 |
| Tinuvin ® 292⁶ | 0.20 | 0.20 | 0.20 | 0.20 | 0.20 | 0.20 |
| Tinuvin ® 1130⁷ | 0.20 | 0.20 | 0.20 | 0.20 | 0.20 | 0.20 |
| Irganox ® 1135⁸ | 0.20 | 0.20 | 0.20 | 0.20 | 0.20 | 0.20 |
| REAXIS ® C 226⁹ | 0.10 | 0.10 | 0.10 | 0.10 | 0.10 | 0.10 |
| Dynasylan ® VTMO¹⁰ | 1.00 | 1.00 | 1.00 | 1.00 | 1.00 | 1.00 |
| Physical Test Results | | | | | | |
| Tensile (PSI) | 175 | 128 | 68 | 171 | 140 | 109 |
| Modulus at 100% | 77 | 54 | 25 | 132 | 111 | 54 |
| extension (PSI) | | | | | | |
| Elongation (%) | 655 | 669 | 516 | 285 | 246 | 408 |
| Tear (PLI) | 42 | 32 | 19 | 45 | 37 | 26 |
| Shore A Hardness | 27 (27) | 21 (21) | 10 (10) | 45 (44) | 38 (37) | 21 (20) |
| 1 Sec (5 Sec) | | | | | | |

¹plasticizer commercially available from LANXESS
²calcium carbonate filler available from Specialty Minerals Inc.
³calcium carbonate filler available for IMERYS
⁴calcium carbonate filler available for IMERYS
⁵treated silica thixotrope available from Cabot Corporation
⁶liquid hindered-amine light stabilizer (HALS) from BASF
⁷liquid UV absorber from BASF
⁸antioxidant from BASF
⁹tin catalyst available from REAXIS
¹⁰vinyl trimethoxy silane available from Evonik

### Example 3

### Modulus of Plasticizer Containing Sealants Versus a Blend of Low Index Prepolymers Made from 22,000 MW Polyols

Sealant formulations were prepared using the ingredients and amounts (percent by weight) listed in Table 3. Fillers and plasticizers were placed in a vacuum oven and heated at 60° C. under reduced pressure. All components except the fillers and catalyst were added into a Flack Tech cup, and then placed in a spin mixer for 10 seconds at 2700 rpm. The filler was added and the cup placed back in the Flack Tech mixer and mixed until homogenous. The catalyst was added and the Flack Tech cup was mixed for an additional 10 seconds at 2700 rpm. The sealant composition was drawn down on polypropylene plastic sheets at 100 mils and allowed to cure at room temperature for 7 days.

Once cured, the films were submitted for physical testing. Results of physical testing for the cured films are set forth in Table 3. Tensile strength at break, maximum elongation, and modulus at 100% extension were determined by ASTM D412, Method A. Tear resistances were determined by ASTM D624, Die “C”. Shore A hardness was determined by ASTM D 2240.

TABLE 3

| | 3A | 3B | 3C | 3D |
|---|---|---|---|---|
| SILANE B | 23.66 | 19.91 | 16.16 | 8.64 |
| SILANE C | 7.14 | 10.89 | 14.64 | 22.16 |
| MESAMOLL ®¹ | 15.0 | 15.0 | 15.0 | 15.0 |
| ULTRA-PFLEX ®² | 7.50 | 7.50 | 7.50 | 7.50 |
| Atomite ®³ | 12.50 | 12.50 | 12.50 | 12.50 |
| Drikalite ®⁴ | 30.0 | 30.0 | 30.0 | 30.0 |
| TiO₂ | 1.00 | 1.00 | 1.00 | 1.00 |
| CAB-O-SIL ® TS 720⁵ | 1.50 | 1.50 | 1.50 | 1.50 |
| Tinuvin ® 292⁶ | 0.20 | 0.20 | 0.20 | 0.20 |
| Tinuvin ® 1130⁷ | 0.20 | 0.20 | 0.20 | 0.20 |
| Irganox ® 1135⁸ | 0.20 | 0.20 | 0.20 | 0.20 |
| REAXIS ® C 226⁹ | 0.10 | 0.10 | 0.10 | 0.10 |
| Dynasylan ® VTMO¹⁰ | 1.00 | 1.00 | 1.00 | 1.00 |
| Physical Test Results | | | | |
| Tensile (PSI) | 134 | 112 | 103 | 104 |
| Modulus at 100% extension (PSI) | 62 | 52 | 51 | 40 |
| Elongation (%) | 588 | 541 | 479 | 624 |
| Tear (PLI) | 32 | 30 | 31 | 26 |
| Shore A Hardness 1 Sec (5 Sec) | 22 (21) | 20 (19) | 15 (15) | 15 (14) |

### Example 4

### Modulus of Low Plasticizer Containing to No Plasticizer Containing Sealants Versus Lowest Index Prepolymer Made from 22,000 MW Polyols

Sealant formulations were prepared using the ingredients and amounts (percent by weight) listed in Table 4. Fillers and plasticizers were placed in a vacuum oven and heated at 60° C. under reduced pressure. All components except the fillers and catalyst were added into a Flack Tech cup, and then placed in a spin mixer for 10 seconds at 2700 rpm. The filler was added and the cup placed back in the Flack Tech mixer and mixed until homogenous. The catalyst was added and the Flack Tech cup was mixed for an additional 10 seconds at 2700 rpm. The sealant composition was drawn down on polypropylene plastic sheets at 100 mils and allowed to cure at room temperature for 7 days.

Once cured, the films were submitted for physical testing. Results of physical testing for the cured films are set forth in Table 3. Tensile strength at break, maximum elongation, and modulus at 100% extension were determined by ASTM D412, Method A. Tear resistances were determined by ASTM D624, Die “C”. Shore A hardness was determined by ASTM D 2240.

TABLE 4

| | 4A | 4B | 4C | 4D | 4E | 4F | 4G |
|---|---|---|---|---|---|---|---|
| SILANE C | 30.80 | 30.80 | 30.80 | 45.8 | 40.80 | 35.80 | 34.12 |
| MESAMOLL ®¹ | 10.0 | 5.0 | 0 | 0 | 5.0 | 10.0 | 0 |
| ULTRA-PFLEX ®² | 8.25 | 9.00 | 9.75 | 7.50 | 7.50 | 7.50 | 9.18 |
| Atomite ®³ | 13.75 | 15.00 | 16.25 | 12.50 | 12.50 | 12.50 | 15.31 |
| Drikalite ®⁴ | 33.0 | 36.0 | 39.0 | 30.0 | 30.0 | 30.0 | 36.73 |
| TiO₂ | 1.00 | 1.00 | 1.00 | 1.00 | 1.00 | 1.00 | 1.11 |
| CAB-O-SIL ® TS 720⁵ | 1.50 | 1.50 | 1.50 | 1.50 | 1.50 | 1.50 | 1.66 |
| Tinuvin ® 292⁶ | 0.20 | 0.20 | 0.20 | 0.20 | 0.20 | 0.20 | 0.22 |
| Tinuvin ® 1130⁷ | 0.20 | 0.20 | 0.20 | 0.20 | 0.20 | 0.20 | 0.22 |
| Irganox ® 1135⁸ | 0.20 | 0.20 | 0.20 | 0.20 | 0.20 | 0.20 | 0.22 |
| REAXIS ® C 226⁹ | 0.10 | 0.10 | 0.10 | 0.10 | 0.10 | 0.10 | 0.11 |
| Dynasylan ® VTMO¹⁰ | 1.00 | 1.00 | 1.00 | 1.00 | 1.00 | 1.00 | 1.11 |
| Physical Test Results | | | | | | | |
| Tensile (PSI) | 74 | 99 | X^{a} | 113 | 92 | 94 | 95 |
| Modulus at 100% extension | 32 | 55 | X | 47 | 38 | 38 | 77 |
| (PSI) | | | | | | | |
| Elongation (%) | 500 | 475 | X | 609 | 512 | 519 | 261 |
| Tear (PLI) | 24 | 24 | X | 30 | 27 | 26 | 28 |
| Shore A Hardness 1 Sec (5 Sec) | 15 (14) | 17 (16) | X | 15 (14) | 15 (15) | 10 (9) | 25 (24) |

^{a}—“X” means that the sealant could not be removed from plastic substrate for testing

### Example 5

### Modulus of Plasticizer Free Sealants Versus Percentage of Intermediate Index Prepolymers Made from 22,000 MW Polyols

Sealant formulations were prepared using the ingredients and amounts (percent by weight) listed in Table 5. Fillers and plasticizers were placed in a vacuum oven and heated at 60 C under reduced pressure. All components except the fillers and catalyst were added into a Flack Tech cup, and then placed in a spin mixer for 10 seconds at 2700 rpm. The filler was added and the cup placed back in the Flack Tech mixer and mixed until homogenous. The catalyst was added and the Flack Tech cup was mixed for an additional 10 seconds at 2700 rpm. The sealant composition was drawn down on polypropylene plastic sheets at 100 mils and allowed to cure at room temperature for 7 days.

Once cured, the films were submitted for physical testing. Results of physical testing for the cured films are set forth in Table 4. Tensile strength at break, maximum elongation, and modulus at 100% extension were determined by ASTM D412, Method A. Tear resistances were determined by ASTM D624, Die “C”. Shore A hardness was determined by ASTM D 2240.

TABLE 5

| | 5A | 5B | 5C | 5D | 5E |
|---|---|---|---|---|---|
| SILANE A | 35 | 40 | 45 | 50 | 55 |
| SILANE B | — | — | — | — | — |
| ULTRA-PFLEX ®² | 9.12 | 8.37 | 7.62 | 6.87 | 6.12 |
| Atomite ®³ | 15.2 | 13.95 | 12.70 | 11.45 | 10.20 |
| Drikalite ®⁴ | 36.48 | 33.48 | 30.48 | 27.48 | 24.48 |
| TiO₂ | 1.00 | 1.00 | 1.00 | 1.00 | 1.00 |
| CAB-O-SIL ® TS 720⁵ | 1.50 | 1.50 | 1.50 | 1.50 | 1.50 |
| Tinuvin ® 292⁶ | 0.20 | 0.20 | 0.20 | 0.20 | 0.20 |
| Tinuvin ® 1130⁷ | 0.20 | 0.20 | 0.20 | 0.20 | 0.20 |
| Irganox ® 1135⁸ | 0.20 | 0.20 | 0.20 | 0.20 | 0.20 |
| REAXIS ® C 226⁹ | 0.10 | 0.10 | 0.10 | 0.10 | 0.10 |
| Dynasylan ® VTMO¹⁰ | 1.00 | 1.00 | 1.00 | 1.00 | 1.00 |
| Physical Test Results | | | | | |
| Tensile (PSI) | 179 | X | X | 163 | 161 |
| Modulus at 100% | 176 | X | X | 132 | 128 |
| extension (PSI) | | | | | |
| Elongation (%) | 162 | X | X | 234 | 234 |
| Tear (PLI) | 54 | X | X | 47 | 50 |
| Shore A Hardness 1 Sec | 56 (55) | X | X | 47 (47) | 44 (44) |
| (5 Sec) | | | | | |
| | 5F | 5G | 5H | 5I | 5J |
| SILANE A | — | — | — | — | — |
| SILANE B | 35 | 40 | 45 | 50 | 55 |
| ULTRA-PFLEX ®² | 9.12 | 8.37 | 7.62 | 6.87 | 6.12 |
| Atomite ®³ | 15.2 | 13.95 | 12.70 | 11.45 | 10.20 |
| Drikalite ®⁴ | 36.48 | 33.48 | 30.48 | 27.48 | 24.48 |
| TiO₂ | 1.00 | 1.00 | 1.00 | 1.00 | 1.00 |
| CAB-O-SIL ® TS 720⁵ | 1.50 | 1.50 | 1.50 | 1.50 | 1.50 |
| Tinuvin ® 292⁶ | 0.20 | 0.20 | 0.20 | 0.20 | 0.20 |
| Tinuvin ® 1130⁷ | 0.20 | 0.20 | 0.20 | 0.20 | 0.20 |
| Irganox ® 1135⁸ | 0.20 | 0.20 | 0.20 | 0.20 | 0.20 |
| REAXIS ® C 226⁹ | 0.10 | 0.10 | 0.10 | 0.10 | 0.10 |
| Dynasylan ® VTMO¹⁰ | 1.00 | 1.00 | 1.00 | 1.00 | 1.00 |
| Physical Test Results | | | | | |
| Tensile (PSI) | X | X | X | 172 | 155 |
| Modulus at 100% | X | X | X | 129 | 113 |
| extension (PSI) | | | | | |
| Elongation (%) | X | X | X | 306 | 280 |
| Tear (PLI) | X | X | X | 47 | 42 |
| Shore A Hardness 1 Sec | X | X | X | 37 (37) | 40 (39) |
| (5 Sec) | | | | | |

### Example 6

### Modulus of Plasticizer Free Sealants Versus Percentage of the Lowest Index Prepolymers Made from 22,000 and 18,000 MW Polyols

Sealant formulations were prepared using the ingredients and amounts (percent by weight) listed in Table 6. Fillers and plasticizers were placed in a vacuum oven and heated at 60° C. under reduced pressure. All components except the fillers and catalyst were added into a Flack Tech cup, and then placed in a spin mixer for 10 seconds at 2700 rpm. The filler was added and the cup placed back in the Flack Tech mixer and mixed until homogenous. The catalyst was added and the Flack Tech cup was mixed for an additional 10 seconds at 2700 rpm. The sealant composition was drawn down on polypropylene plastic sheets at 100 mils and allowed to cure at room temperature for 7 days.

Once cured, the films were submitted for physical testing. Results of physical testing for the cured films are set forth in Table 5. Tensile strength at break, maximum elongation, and modulus at 100% extension were determined by ASTM D412, Method A. Tear resistances were determined by ASTM D624, Die “C”. Shore A hardness was determined by ASTM D 2240.

TABLE 6

| | 6A | 6B | 6C | 6D | 6E |
|---|---|---|---|---|---|
| SILANE C | 35 | 40 | 45 | 50 | 55 |
| SILANE F | — | — | — | — | — |
| ULTRA-PFLEX ®² | 9.12 | 8.37 | 7.62 | 6.87 | 6.12 |
| Atomite ®³ | 15.2 | 13.95 | 12.70 | 11.45 | 10.20 |
| Drikalite ®⁴ | 36.48 | 33.48 | 30.48 | 27.48 | 24.48 |
| TiO₂ | 1.00 | 1.00 | 1.00 | 1.00 | 1.00 |
| CAB-O-SIL ® TS 720⁵ | 1.50 | 1.50 | 1.50 | 1.50 | 1.50 |
| Tinuvin ® 292⁶ | 0.20 | 0.20 | 0.20 | 0.20 | 0.20 |
| Tinuvin ® 1130⁷ | 0.20 | 0.20 | 0.20 | 0.20 | 0.20 |
| Irganox ® 1135⁸ | 0.20 | 0.20 | 0.20 | 0.20 | 0.20 |
| REAXIS ® C 226⁹ | 0.10 | 0.10 | 0.10 | 0.10 | 0.10 |
| Dynasylan ® VTMO¹⁰ | 1.00 | 1.00 | 1.00 | 1.00 | 1.00 |
| Physical Test Results | | | | | |
| Tensile (PSI) | 113 | 106 | 114 | 87 | 97 |
| Modulus at 100% | 92 | 78 | 46 | 41 | 38 |
| extension (PSI) | | | | | |
| Elongation (%) | 259 | 214 | 530 | 347 | 440 |
| Tear (PLI) | 28 | 28 | 33 | 30 | 24 |
| Shore A Hardness 1 Sec | 30 (28) | 23 (22) | 20 (20) | 16 (16) | 16 (15) |
| (5 Sec) | | | | | |
| | 6F | 6G | 6H | 6I | 6J |
| SILANE C | — | — | — | — | — |
| SILANE F | 35 | 40 | 45 | 50 | 55 |
| ULTRA-PFLEX ®² | 9.12 | 8.37 | 7.62 | 6.87 | 6.12 |
| Atomite ®³ | 15.2 | 13.95 | 12.70 | 11.45 | 10.20 |
| Drikalite ®⁴ | 36.48 | 33.48 | 30.48 | 27.48 | 24.48 |
| TiO₂ | 1.00 | 1.00 | 1.00 | 1.00 | 1.00 |
| CAB-O-SIL ® TS 720⁵ | 1.50 | 1.50 | 1.50 | 1.50 | 1.50 |
| Tinuvin ® 292⁶ | 0.20 | 0.20 | 0.20 | 0.20 | 0.20 |
| Tinuvin ® 1130⁷ | 0.20 | 0.20 | 0.20 | 0.20 | 0.20 |
| Irganox ® 1135⁸ | 0.20 | 0.20 | 0.20 | 0.20 | 0.20 |
| REAXIS ® C 226⁹ | 0.10 | 0.10 | 0.10 | 0.10 | 0.10 |
| Dynasylan ® VTMO¹⁰ | 1.00 | 1.00 | 1.00 | 1.00 | 1.00 |
| Physical Test Results | | | | | |
| Tensile (PSI) | X | 132 | 135 | 142 | 143 |
| Modulus at 100% | X | 99 | 82 | 76 | 64 |
| extension (PSI) | | | | | |
| Elongation (%) | X | 285 | 415 | 461 | 481 |
| Tear (PLI) | X | 32 | 37 | 36 | 34 |
| Shore A Hardness 1 Sec | X | 32 (31) | 32 (31) | 31 (30) | 26 (25) |
| (5 Sec) | | | | | |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112, first paragraph, and 35 U.S.C. §132(a).

1. An alkoxysilane-group modified polyurethane that is the reaction product of:
(1) a polyoxyalkylene polyol having a molecular weight of at least 18,000 gram/mole, a polydispersity of less than 1.5 and a content of unsaturated end groups of no more than 0.02 meq/gram polyol, measured according to ASTM D2849-69; and
(2) a compound of the formula:
ONC—Y—Si—(X)₃,
wherein: (i) each X independently represents identical or different alkoxy radicals, and (ii) Y represents a difunctional organic radical, and wherein a weight average molar ratio of isocyanate groups of (2) to hydroxyl groups of (1) used to make the polyurethane is less than 0.80:1.

2. The alkoxysilane-group modified polyurethane of claim 1, wherein the polyoxyalkylene polyol is a diol.

3. The alkoxysilane-group modified polyurethane of claim 1, wherein the polyoxyalkylene polyol has a molecular weight of greater than 20,000 g/mol to 30,000 g/mol.

4. The alkoxysilane-group modified polyurethane of claim 3, wherein the polyoxyalkylene polyol has a molecular weight of 21,000 g/mol to 25,000 g/mol.

5. The alkoxysilane-group modified polyurethane of claim 1, wherein the weight average molar ratio of isocyanate groups of (2) to hydroxyl groups of (1) used to make the polyurethane is no more than 0.76:1.

6. The alkoxysilane-group modified polyurethane of claim 5, wherein the weight average molar ratio of isocyanate groups of (2) to hydroxyl groups of (1) used to make the polyurethane is 0.5 to 0.76:1.

7. The alkoxysilane-group modified polyurethane of claim 1, wherein the polyoxyalkyene polyol has a content of unsaturated end groups of no more than 0.01 meq/gram diol, measured according to ASTM D2849-69.

8. (canceled)

9. The alkoxysilane-group modified polyurethane of claim 8, wherein the polydispersity is 1.05 to 1.15.

10. A composition comprising:
(i) 10 to 50 percent by weight, based on the total weight of the composition, of the alkoxysilane-group modified polyurethane of claim 1; and
(ii) 0 to 15 percent by weight, based on the total weight of the composition, of an inert plasticizer.

11. The composition of claim 10, further comprising:
(b) 20 to 60 percent by weight of a filler, based on the total weight of the composition.

12. A cured sealant produced from the composition of claim 10, wherein the sealant has a modulus at 100% extension of no more than 0.41 MPa when measured according to ASTM D412, Method A.

13. A moisture curable composition comprising:
(a) an alkoxysilane-group modified polyurethane comprising a reaction product of:
(1) a polyoxyalkylene polyol having a molecular weight of at least 18,000 gram/mole, a polydispersity of less than 1.5, and a content of unsaturated end groups of no more than 0.07 meq/gram diol, measured according to ASTM D2849-69; and
(2) a compound of the formula:
ONC—Y—Si—(X)₃,
wherein: (i) each X independently represents identical or different alkoxy radicals, and (ii) Y represents a difunctional organic radical, and
wherein a weight average molar ratio of isocyanate groups of (2) to hydroxyl groups of (1) used to make the polyurethane is less than 0.80:1;
(b) a filler; and
(c) 0 to 15% by weight, based on the total weight of the composition, of an inert plasticizer.

14. The composition of claim 13, wherein the polyoxyalkyene polyol is a diol.

15. The composition of claim 14, wherein the polyoxyalkyene polyol has a content of unsaturated end groups of no more than 0.01 meq/gram diol, measured according to ASTM D2849-69.

16. The composition of claim 13, wherein the molecular weight is 21,000 to 25,000 gram/mole.

17. The composition of claim 13, wherein the weight average molar ratio of isocyanate groups of (2) to hydroxyl groups of (1) used to make the polyurethane is no more than 0.76:1.

18. A cured sealant produced from the composition of claim 13, wherein the sealant has a modulus at 100% extension of no more than 0.41 MPa when measured according to ASTM D412, Method A.

19. A cured sealant having a modulus at 100% extension of no more than 0.41 MPa when measured according to ASTM D412, Method A, wherein the cured sealant is produced from a composition comprising:
(a) an alkoxysilane-group modified polyurethane comprising a reaction product of:
(1) a polyoxyalkylene polyol having a molecular weight of at least 18,000 gram/mole and a polydispersity of less than 1.5; and
(2) a compound of the formula:
ONC—Y—Si—(X)₃,
wherein: (i) each X independently represents identical or different alkoxy radicals, and (ii) Y represents a difunctional organic radical, and
wherein a weight average molar ratio of isocyanate groups of (2) to hydroxyl groups of (1) used to make the polyurethane is less than 0.80;
(b) a filler; and
(c) 0 to 15% by weight, based on the total weight of the composition, of an inert plasticizer.

20. The cured sealant of claim 19, wherein the polyoxyalkyelene polyol is a diol.
